(19) United States
(12) Patent Application Publication
(10) Pub. No.: US 2010/0119342 A1
(43) Pub. Date: May 13, 2010

(54) Spare Wheel Security, Storage, and Transportation Device

(76) Inventor: Leo Russ, Englewood, CO (US)

Correspondence Address: Leo Russ, 16191 East Phillips Drive, Englewood, CO, 80112, US

(21) Appl. No.: 12/268,458

(22) Filed: Nov. 11, 2008

(51) Int. Cl. B62D 43/10; B23P 19/00

(52) U.S. Cl. 414/463; 29/700

(57) ABSTRACT

A Spare Wheel Security and Carrying Device for protecting from theft and assisting in removal and installation of an undercarriage-mounted spare wheel assembly having frame/cradle with protective bars or mesh the spare wheel is resting upon, mounting means for secure engagement with the factory-installed winch mechanism, casters for convenient transportation of the spare wheel assembly, and a fixed or extendable handle. Use of the hereby disclosed device requires no modifications or additions to the existing manufacturer-installed hardware so that it can be removed from the vehicle, and the spare wheel can be mounted directly using the original equipment, and the said Device can be used as a stand-alone universal cart for carrying heavy items.

### TECHNICAL FIELD AND INDUSTRIAL APPLICABILITY OF THE INVENTION

This invention relates to the truck or SUV spare wheel assembly. The present invention relates particularly to the undercarriage-stored spare wheel assembly and is intended to prevent theft and simplify removal and installation of the said spare wheel assembly.

### BACKGROUND OF THE INVENTION

In most sport utility vehicles (SUV) and pickup trucks, the spare wheel assembly is located on the rear underside of the vehicle. A winch type mechanism mounted to the undercarriage of the vehicle is used to lift and press the spare wheel against the bottom of the vehicle body (undercarriage) where it is stored. The said winch mechanism uses a cable with a yoke as attachment means. This cable is easily accessible from underneath and a thief can cut the cable to release and steal the spare wheel assembly. Thus the owner will have the expense of replacing the entire winch mechanism as well as the spare wheel assembly.

Also, SUV as well as pickup truck wheels may weigh in excess of 100 lbs and are difficult to pull from under the vehicle for removal and installation. A spare wheel stored under the vehicle is usually covered with dirt and mud which makes the removal and installation procedure quite difficult and associated with significant inconvenience.

In addition, a spare wheel installation on a wheel hub requires lifting of the wheel from the ground to the level of the axle hub which—considering significant weight of the wheel assembly—is not a task an average person can physically perform.

The disclosed hereby invention solves all three listed problems—security, difficulty and inconvenience associated with removal and installation undercarriage-stored spare wheel assembly for storage, and installation of a spare wheel on the vehicle hub. It can also be used as a general purpose cart.

### PRIOR ART

Hereby, for reference purposes, is disclosed a U.S. Pat. No. 7,195,231 B2 “Spare Tire Security System” issued to Richard E. Murphy as addressing one issue—namely, security—related to an undercarriage-mounted spare wheel assembly. The following is intended to compare the Murphy's invention and the presently disclosed “Spare Wheel Security and Carrying Device”.

Both inventions prevent access to the winch cable so that the said cable could not be cut and the spare wheel could not be stolen but the actual implementations are different. The main differences representing the advantages of the hereby disclosed “Spare Wheel Security and Carrying Device” are as follows.

The Murphy's system adds additional mounting hardware to attach the cover plate to the spare wheel which makes removal and installation procedures even more complex and inconvenient than the original setup utilized by the factory while the hereby disclosed Device not only restricts access to the winch cable thus preventing it from being cut and the spare wheel stolen but also utilizes no additional bolts, nuts, or other mounting hardware thus adding no extra steps to the installation and removal process of the spare wheel.

The Murphy's system utilizes the original factory-intended way to attach the spare wheel to the vehicle—the winch cable yoke is inserted through the spare wheel rim center hole while the hereby disclosed Device is engaged with the yoke, and the spare wheel is rested on top of the Device between the Device cradle and the vehicle undercarriage thus making removal and installation of both the Device and the spare tire a single-step process.

The Murphy's system uses a protection plate attached to the spare wheel by means of additional hardware while the hereby disclosed Device is attached using the standard factory-installed winch mechanism, cable and yoke. The said yoke is attached in the manner similar to that utilized by the factory but to the hereby disclosed device rather than to the spare wheel rim so that the spare wheel is supported by the hereby disclosed Device.

Unlike Murphy's system, the hereby disclosed Device provides additional functionality—it simplifies removal and installation of the spare wheel for storage and transportation under the vehicle body and assists in replacement of a flat tire. It can also be used as a general-purpose cart. These extra functions add no additional complexity to the main functionality—storage and protection of the spare wheel assembly.

### BRIEF DESCRIPTION OF THE DRAWINGS

The drawings the following description is related to are meant to display possible physical characteristics of the present invention and are not to be taken in a limiting sense. It is understood that other embodiments may be utilized and that structural changes may be made without departing from the scope of the invention.

The present invention will become more apparent from the following detailed description taken in conjunction with the accompanying drawings, in which:

FIG. 1 is a view of a spare tire mounted under the vehicle in a factory-intended manner.

FIG. 2 is a perspective view of the hereby disclosed Device in an un-installed position, thereby preventing access to the standard factory-installed cable and yoke and simplifying spare wheel installation and removal.

FIG. 3 is a view of a spare wheel installed on a hereby disclosed Device showing the factory-installed yoke and cable in engaged (C2 and F2) and disengaged (C1 and F1) states.

FIG. 4 is a view of a spare wheel installed on a hereby disclosed Device in fully engaged state ready to be lifted with a standard factory-installed winch mechanism of which only the yoke and the cable are shown.

FIG. 5 is a view of hereby disclosed Device mounted to the undercarriage of a vehicle with the spare wheel assembly secured.

FIG. 6 demonstrates the spare wheel installation procedure on the vehicle hub using hereby disclosed Spare Device.

FIG. 7 is a view of hereby disclosed Device with yoke hookups in a lowered state suitable for utilizing the said Device as a general-purpose cart.

FIG. 8 is an isometric view of a caster assembly mounted on a round profile tube using one-piece mount.

FIG. 9 shows caster assemblies mounted on tubes of various profiles using one-piece mount.

### DETAILED DESCRIPTION OF THE INVENTION

A Spare Wheel Security and Carrying device (further referred to as Device) comprises a cradle (frame) fitted with bars, perforated plate, or metal mesh preventing access to the center part of the spare wheel and the mounting cable thus preventing the said cable from being cut, and the spare wheel released and stolen. The said bars or mesh also serve as a platform supporting load when the Device is used as a general purpose cart.

The said Device is connected directly to the factory-installed winch mechanism using a standard yoke so that the spare wheel is resting on the cradle which, in turn, is pulled upwards by means of the standard winch mechanism cable and forces the spare wheel to be securely pressed against the vehicle's undercarriage for storage and transportation. This setup requires no hardware, tools, or other means for removal, installation, or transportation of the said Device and the spare wheel, and it is easier to engage the cable yoke with the said Device than with the spare wheel rim as provided by standard setup.

The hereby disclosed Device simplifies the spare wheel removal, installation, transportation, and replacement and allows the spare tire to be mounted hollow (inner) side towards the bottom of the vehicle thus further simplifying spare wheel lifting required for installation on the vehicle axle hub. The frame may also be fitted with casters used to transport the spare tire, a handle for ease of use, and lifting supports for easy wheel elevation to the level of the vehicle axle hub.

Use of the hereby disclosed device requires no modifications or additions to the existing manufacturer-installed hardware so the disclosed Device can be removed from the vehicle, and the spare wheel can be mounted directly using the original equipment, and the said Device can be used as a stand-alone universal cart for carrying heavy items.

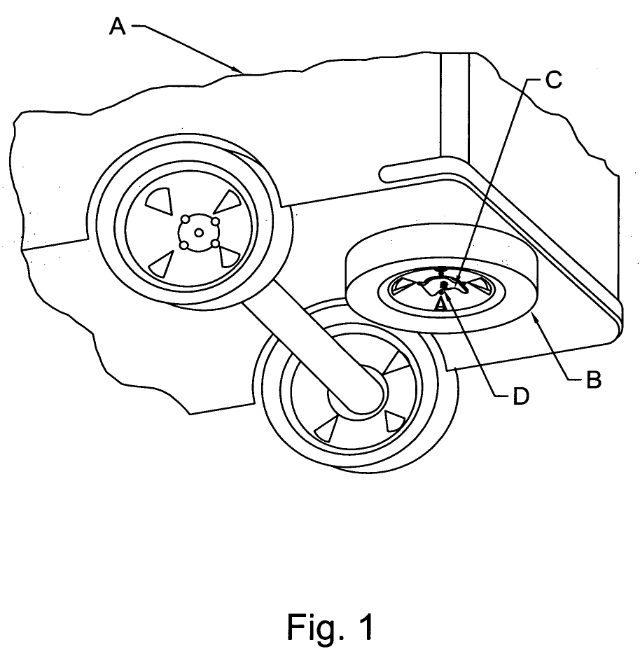

Referring to FIG. 1, the existing factory-installed spare wheel B is mounted to the undercarriage of a vehicle A using a yoke C attached to the winch cable (not visible) by means of a cable stop D. This setup allows easy access to the winch cable the yoke C is attached to. Once the cable is cut, the spare wheel is released and stolen.

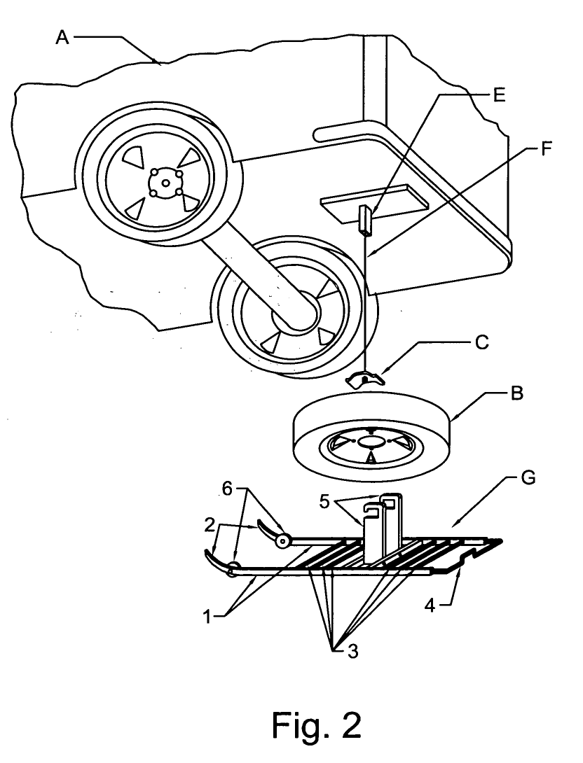

Referring to FIG. 2, the existing factory-installed spare wheel B is mounted to the undercarriage of a vehicle A using a yoke C attached to the winch E by means of cable F, the hereby disclosed Spare Wheel Security and Carrying Device G comprised of frame 1, lifting supports 2 used to elevate a spare wheel to the level of the wheel hub, load support/access restriction bars/mesh 3 preventing access to the winch cable thereby reducing a possibility of theft and serving as a support for load when the Device is used as a common-purpose cart, handle 4 providing convenient means for pulling the spare wheel from under the vehicle and for transporting the wheel or load, yoke hookups 5 used to engage the device with the original factory-installed yoke C attached to the factory-installed winch mechanism E, and casters 6 used to roll the Device with the spare wheel of load (when utilized as a general-purpose cart).

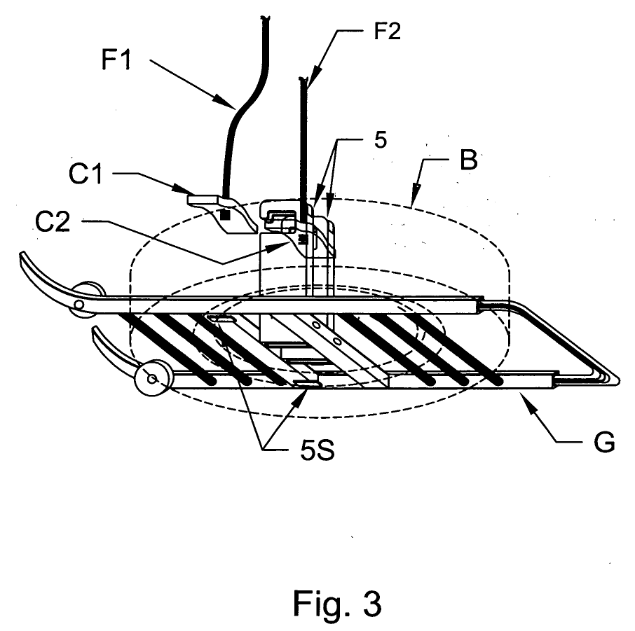

Referring to FIG. 3, the hereby disclosed Device in connected and disconnected states where spare wheel B, yoke in disengaged state C1, yoke in engaged state C2, winch cable in disengaged state F1, winch cable in engaged state F2, yoke hookups 5, yoke hookup tabs 5S used to keep the yoke hookups 5 in lowered state when the Device is used as a general-purpose cart.

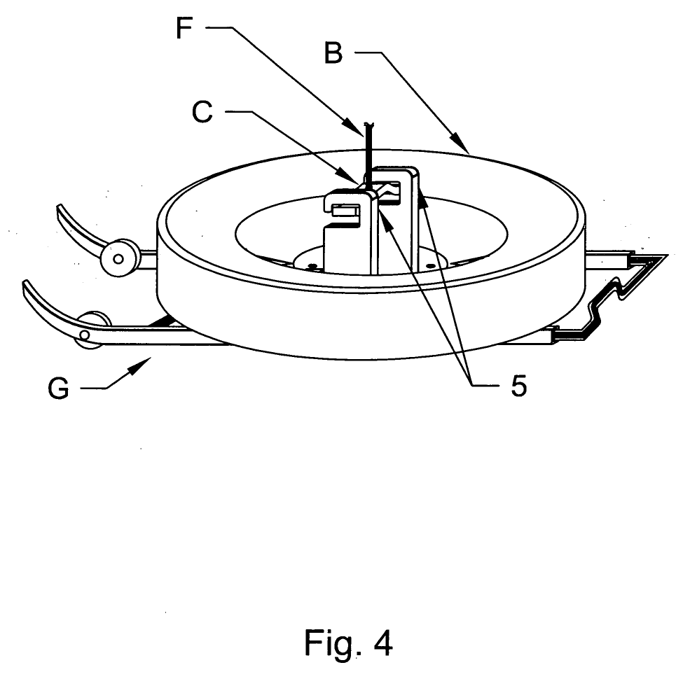

Referring to FIG. 4, the hereby disclosed Device G in fully engaged yoke C with yoke hookups 5 state with the spare wheel B installed ready to be lifted by the factory-installed winch mechanism (not shown) by means of the original winch cable F.

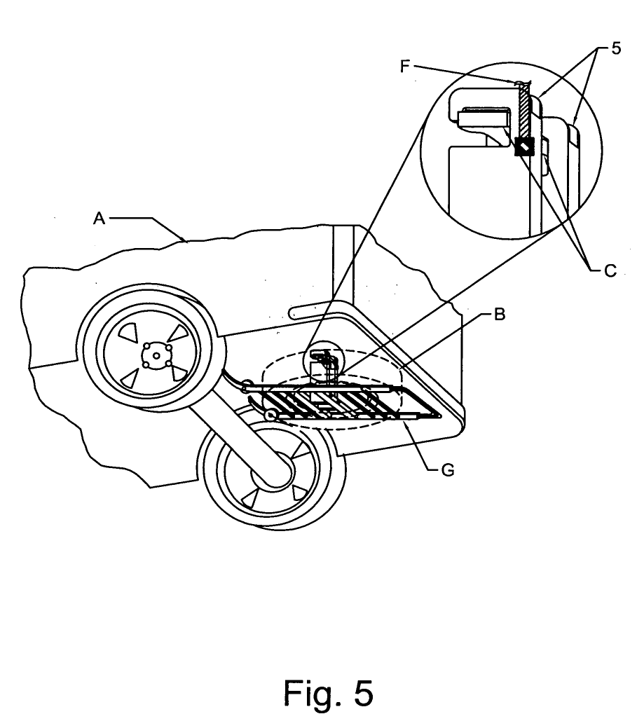

Referring to FIG. 5, the hereby disclosed device G with the spare wheel B lifted and pressed against the truck A undercarriage by means of the factory-installed yoke C and which cable F engaged with the yoke hookups 5.

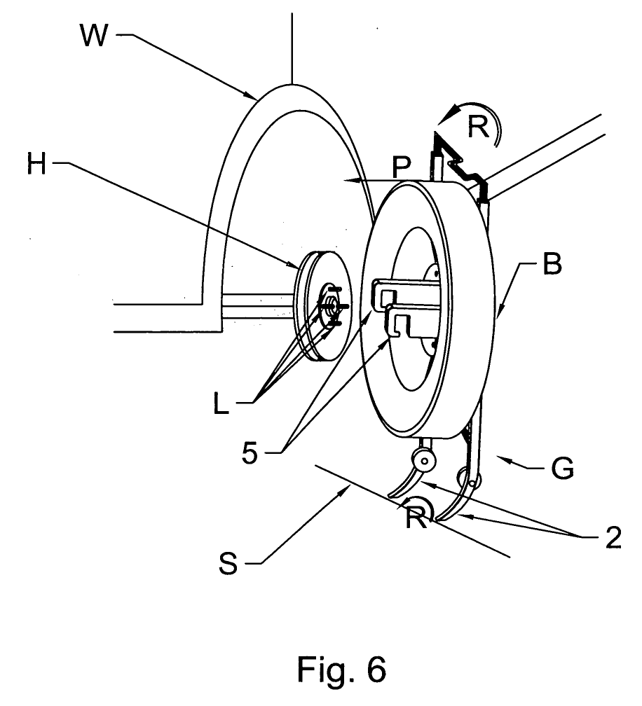

Referring to FIG. 6, the hereby disclosed device G function in spare wheel B installation on the vehicle axle hub H. Lifting supports 2 are pressed against ground surface S, the Device G is rotated in the direction shown with arrows R, and the spare wheel B is pushed off the yoke hookups 5 towards the hub H (in this case—onto lug studs L) in direction P. W—vehicle wheel well.

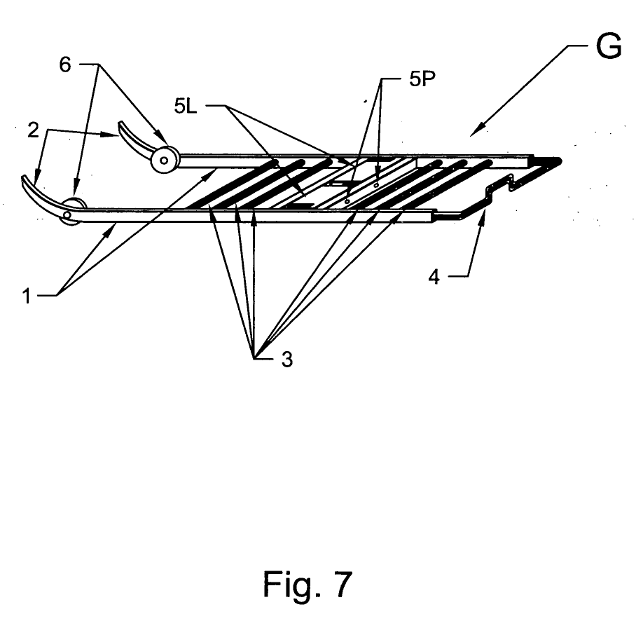

Referring to FIG. 7, the hereby disclosed device G with the yoke hookups 5L rotated about yoke hookup pins 5P into lowered position suitable for use of the Device as a common-purpose cart. Other items shown: frame 1, lifting supports 2, load support/access restriction bars/mesh 3, handle 4, casters 6.

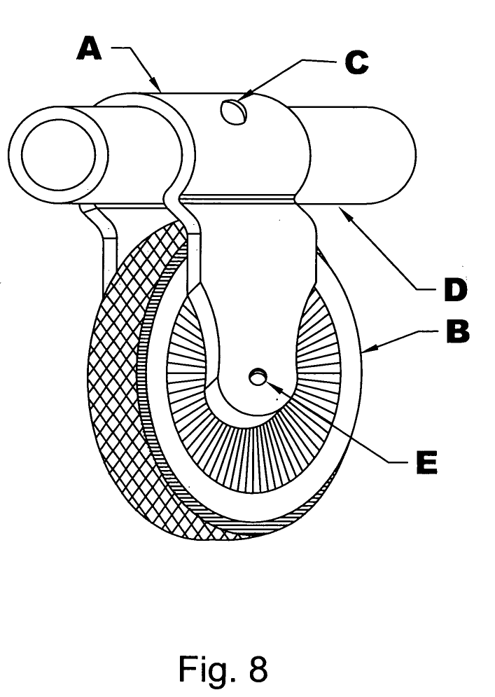

Referring to FIG. 8, it shows a single-piece caster/bracket assembly where A is a bracket/mount, B—caster, C—mounting hardware such as screws or rivets, D—frame tube segment (in this case, round), E—caster axle.

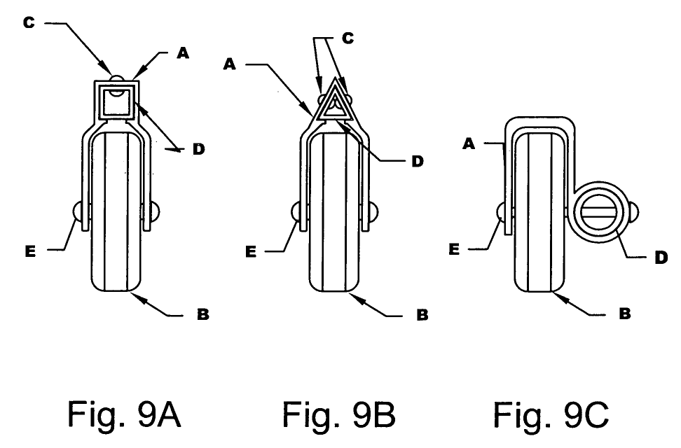

Referring to FIG. 9A, it shows a single-piece caster/bracket assembly where A is a bracket/mount, B—caster, C—mounting hardware such as screws or rivets, D—frame tube segment (in this case, square), E—caster axle.

Referring to FIG. 9B, it shows a single-piece caster/bracket assembly where A is a bracket/mount, B—caster, C—mounting hardware such as screws or rivets, D—frame tube segment (in this case, triangular), E—caster axle.

Referring to FIG. 9C, it shows an example of yet another way of mounting a single-piece caster/bracket assembly where A is a bracket/mount, B—caster, D—frame tube segment (in this case, round), E—caster axle in this setup serving as attachment/mounting means.

What is claimed is:

1. A security device (further referred to as “Device”) for securing, storing, and transporting a spare wheel located at the underside of a vehicle, the security device comprising:
a spare wheel;
a winch mechanism including a cable and a yoke;
a frame/cradle assembly with load support and access restriction bars or mesh, one or two yoke hookups, yoke hookup pins, yoke hookup tab(s), lifting support(s), handle, and casters; and, wherein in an installed position, the winch mechanism couples the Device—with the spare wheel residing on top of the frame/cradle—to the underside of the vehicle and presses the spare wheel against the underside of the vehicle while the frame/cradle assembly is pressed to the spare wheel from underneath thus providing secure spare wheel mounting means and preventing access to the winch cable and a yoke.

2. A spare wheel assembly mounting and security device comprising:
a spare wheel;
a frame/cradle assembly; wherein is in installed position, is located underneath the said spare wheel assembly and is engaged with the vehicle thus providing support and secure storage solution of the said spare wheel assembly.

3. The security Device of claim 1, wherein the Device has one or two yoke hookups with slots or holes that receive the standard factory-installed winch mechanism cable yoke as means for lifting the spare wheel assembly and pressing the said spare wheel assembly against the vehicle undercarriage for secure storage.

4. The security device of claim 1, wherein the Device cradle has protective bars or mesh preventing access to the winch cable and providing load support when the Device is used as a general-purpose cart.

5. The security device of claim 1, wherein the Device cradle with protective bars or mesh extends beyond the periphery of the spare wheel rim in installed position.

6. The security device of claim 1, wherein the frame/cradle assembly has one or two yoke hookups that when the spare wheel assembly is installed are inserted through the hole in the spare wheel rim and extend beyond the said rim upper surface and are coupled with the factory-installed yoke thus providing a secure engagement between the said Device and the vehicle and support the spare wheel when the said Device is disengaged from the vehicle and the said Device is utilized as a spare wheel cart or a flat tire replacement aid.

7. The security device of claim 1, wherein the factory-installed winch cable yoke is engaged with the yoke hookup(s) of the hereby disclosed Device rather than with the 35 spare wheel rim as intended by the original factory setup.

8. The security device of claim 1, wherein the factory-installed winch cable yoke resides above the spare wheel rim between the said rim and the vehicle undercarriage.

9. The security device of claim 1, wherein the spare wheel resides on top of the hereby disclosed Device between the Device and the undercarriage of the vehicle where 40 force generated by the factory-installed winch mechanism presses the said Device upwards against the spare wheel, and the spare wheel is pressed against the vehicle undercarriage.

10. The security device of claim 1, wherein the yoke hookup(s) can be lowered to form a flat surface with the cradle.

11. The security device of claim 1, wherein the yoke hookup(s) can be rotated around frame or protective bar(s) mounted pins/axis to form a flat surface with the cradle.

12. The security device of claim 1, wherein the frame or protective bars/mesh has one or more tabs for the yoke hook up(s) to rest upon to form a flat surface when the Device is used as a general-purpose cart.

13. The security device of claim 1, wherein the Device frame has a handle for easy transportation.

14. The security device of claim 13, wherein the Device frame has stationary, adjustable, extendable, or spring-loaded handle to accommodate variations in spare wheel assembly positions implemented by different vehicle manufacturers and for easy transportation.

15. The security device of claim 1, wherein the Device frame has casters for easy transportation.

16. The security device of claim 1, wherein the Device frame extends beyond the caster axis so that the formed extension could serve as a lifting support to assist in spare wheel elevation to the level of the vehicle axle hub to assist in flat tire replacement.

17. The security device of claim 1, wherein the Device frame has a foot- or hand-operated lever allowing to lift the Device so that the hole in the spare wheel rim was 65 lifted and located at the same level as the vehicle axle hub to assist in flat tire replacement.

18. Caster mounting method, wherein a single-piece mounting component serves as caster-to-tube attachment means, and the said mounting component is shaped for optimal engagement with the tube allowing usage of a variety of mounting hardware methods such as screws or rivets, or can also be welded to the tube.
